(19) United States
(12) Patent Application Publication
(10) Pub. No.: US 2002/0166214 A1
(43) Pub. Date: Nov. 14, 2002

(54) Pipe clamp, in particular, pipe coupling

(75) Inventor: Gerhard Wachter, Budingen (DE)

Correspondence Address: Friedrich Kueffner, Suite 1921, 342 Madison Avenue, New York, NY, 10173, US

(73) Assignee: Rasmussen GmbH

(21) Appl. No.: 10/139,470

(22) Filed: May 3, 2002

(30) Foreign Application Priority Data
May 10, 2001 (DE) 101 22 647.0

(51) Int. Cl. F16L 3/12

(52) U.S. Cl. 24/279

(57) ABSTRACT

A pipe clamp has a clamping strip, first and second clamping jaws connected to ends of the clamping strip, a clamping screw, and a nut cooperating with the clamping screw for moving the first and second clamping jaws toward one another when tightening the pipe clamp. Two radially projecting tabs are provided near the first clamping jaw. The nut is arranged between the two radially projecting tabs. At least one of the two radially projecting has a shaped portion which is oriented toward the other one of the two radially projecting. The nut has at least one securing surface. The shaped portion engages the at least one securing surface of the nut radially relative to the clamping strip.

### BACKGROUND OF THE INVENTION

1. Field of the Invention

The invention relates to a pipe clamp, in particular, pipe coupling, comprising a clamp strip, two clamping jaws, a clamping screw, and a nut cooperating with the clamping screw which nut is arranged in the area of one clamping jaw between two radially projecting tabs.

2. Description of the Related Art

Such a pipe clamp is commercially sold under the name “Dükorapid” by the company Eisenwerke Fried. Wilh. Düker GmbH & Co. KGaA, Karlstadt/Main, Germany.

In such pipe clamps, the clamp strip is generally of a circular shape wherein the ends of the clamp strip overlap. At the ends of the clamp strip, two clamping jaws are arranged which are moved toward one another by means of the clamping screw and the nut when the clamping screw is screwed farther into the nut. When the clamping jaws approach one another, the diameter of the space delimited by the clamping strip is reduced so that the pipe clamp can be clamped onto the circumference of a pipe. The same holds true correspondingly when the pipe clamp is used as a pipe coupling and is secured simultaneously on the ends of two pipes in the area of the joint location between the two pipes.

In many cases it is difficult to position the pipe clamp on the pipe. In this situation, the workman usually unscrews the clamping screw completely and removes it from the nut and then bends open the clamping strip. When the clamping strip is subsequently positioned in the desired position, the clamping strip is bent together and the clamping screw is again screwed into the nut in order to advance the clamping jaws toward one another. However, this approach requires a certain dexterity for screwing the clamping screw again into the nut because the nut generally has changed its position in the meantime. It is thus necessary to act additionally on the nut in order to bring it back into the correct position.

### SUMMARY OF THE INVENTION

It is an object of the present invention to facilitate handling of such a pipe clamp.

In accordance with the present invention, this is achieved in that at least one of the tabs has a shaped portion which is oriented toward the other tab and engages a securing surface of the nut radially from behind relative to the clamping strip.

The shaped portion of the tab ensures that the nut is secured relative to the clamping strip in the radial direction. All of the following directional definitions in the following relate to the clamping strip. When the nut is secured in the radial direction, it automatically has the correct position for the clamping screw so that basically it is sufficient to introduce the clamping screw with a rotational movement into the nut. An additional positioning of the nut or a prolonged searching with the tip of the clamping screw is no longer necessary. The mounting time is dramatically shortened. The risk that the nut cants on the clamping screw and thus damages the thread is thus significantly reduced. Accordingly, the reliability of the fastening action of the pipe clamp is increased.

Preferably, the shaped portion is provided at the end of the tab. This facilitates, on the one hand, the manufacture of the pipe clamp. On the other hand, in this way the risk is reduced that portions of the tab are formed which project away from the nut when the nut is attached on the pipe clamp by means of the tab. Such portions present the risk that they could be accidentally bend open so that the nut could drop out of the pipe clamp.

Preferably, the shaped portion is bent out of the tab. The bending process can be realized during the manufacture of the pipe clamp with relatively minimal expenditure because the tabs generally are already bent out of a part which supports one of the clamping jaws.

Preferably, the securing surface is slanted relative to the clamping strip. The slant extends here in the axial direction. This has the advantage that the shaped portion also has only a limited slant and the nut, despite of this, is secured with increased reliability.

Preferably, the securing surface is arranged in a recess within the circumferential surface of the nuts. In this way, the tabs can be relatively short. They must not completely engage all around the nut. Despite of this, a satisfactory reliability of the securing action of the nut on the pipe clamp can be achieved.

Preferably, the tab has a main portion, which cooperates with the securing surface, and an additional portion which is arranged on the side of the nut opposite the clamping jaw. The additional portion has the effect that the nut is also reliably secured in the circumferential direction of the pipe clamp. The circumferential direction of the pipe clamp corresponds to the axial direction of the nut. The nut is thus secured captively within the pipe clamp, i.e., the workman must not carry out additional measures after unscrewing the clamping screw in order to ensure that the nut will not be lost. The nut is secured in the circumferential direction of the clamping strip on one side by the clamping jaw and on the other side by the additional portion.

This can be realized in a very simple way in that the additional portion is longer than the main portion of the tab. When the main portion is bent into a recess in the circumferential surface of the nut, the additional portion projects past the end face of the nut and prevents its movement away from the clamping jaw.

As an alternative or in addition to this, the additional portion can be deformed more strongly toward the opposite tab than the main portion. In this way, it is also possible to position the additional portion in front of the end face of the nut in order to prevent the nut from moving away from the clamping jaw.

Preferably, between the tab and the clamping jaw a spacing is provided. This spacing has mainly manufacturing-technological reasons. When forming the tab out of the part which also supports the clamping jaw, it is prevented that the clamping jaw is negatively affected by this shaping process.

Preferably, both tabs have a shaped portion. The nut is then secured on two opposite sides. This increases the rotational securing of the nut in the pipe clamp and increases the reliability when securing the nut in the pipe clamp.

Preferably, one end face of at least one tab cooperates with a counter surface on the nut. This can be realized particularly simply when the tab is formed to engage a recess. The counter surface improves securing against rotation of the nut on the pipe clamp. When the clamping screw is screwed into the nut, it applies torque onto the nut which tries to rotate the nut in the same direction as the clamping screw. When a counter surface of the nut now contacts an end face of the tab, a rotational movement of the nut is prevented with even more improved reliability because for such a rotational movement a relatively strong deformation of the tab would be required which cannot be realized by a simple torque resulting from the screwing action.

### BRIEF DESCRIPTION OF THE DRAWING

In the drawing:

FIG. 1 shows a side view of the pipe clamp;

FIG. 2 shows a perspective view of the pipe clamp;

FIG. 3 shows a nut which is secured by tabs;

FIG. 4 shows the nut with additional axial securing action;

FIG. 5 shows the nut according to FIG. 4 in a side view;

FIG. 6 shows a clamping jaw in a perspective view;

FIG. 7 shows the clamping jaw according to FIG. 6 with inserted nut; and

FIG. 8 shows different embodiments of nuts.

### DESCRIPTION OF THE PREFERRED EMBODIMENTS

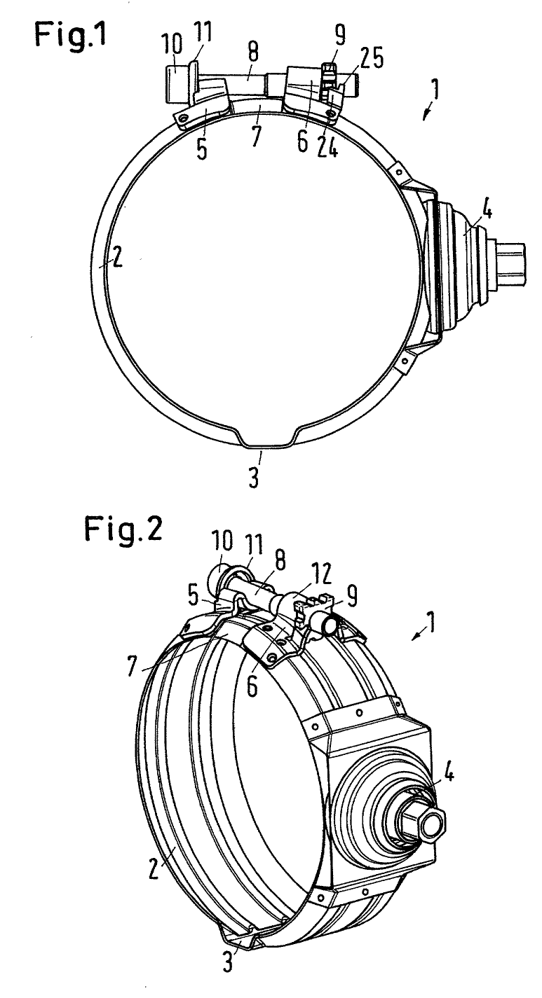

FIG. 1 shows a pipe clamp 1 with a clamping strip 2 which is substantially circular and has a hinged portion 3 where the clamping strip 2 can be bent open during mounting. The clamping strip 2 can be provided with a fastening configuration 4 into which, for example, a threaded bolt can be introduced.

On each end of the clamping strip 2 a clamping jaw 5, 6 is arranged. One end of the clamping strip 2 can be provided with an extension 7 which engages the other end of the clamping strip 2 so that in the situation illustrated in FIG. 1 a circular closed geometry of the clamping strip 2 results.

The two clamping jaws 5, 6 are tightened against one another by means of a clamping bolt 8 which cooperates with one clamping jaw 5 and is threaded into a nut 9 which cooperates with the other clamping jaw 6. When the treaded bolt 8 is threaded into the nut 9, the two clamping jaws 5, 6 are moved toward another. In this way, the diameter of the space surrounded by the clamping strip 2 is reduced. In this way, the pipe clamp 1 can be tightened onto the circumference of a pipe. When the pipe clamp 1 is arranged in the area of the abutting edges of two pipes and has the corresponding axial length, the pipe clamp 1 can also be used as a pipe coupling.

The clamping screw 8 has a screw head 10 which has a collar-shaped projection 11 with which the screw head 10 can be hooked on the clamping jaw 5. In this way, it is ensured that the clamping screw 8 cannot move in the radial direction away from the clamping jaw 5. In a way known in the art, the screw head 10 snaps into place behind the clamping jaw 5 when the clamping strip is compressed.

The other clamping jaw 6 has a portion 12 which is bent like a reverse U-shape. This results in a tunnel-shaped passage between the clamping strip 2 and the portion 12 through which the clamping screw 8 is guided. The nut 9 contacts the end face of this tunnel 13 (FIG. 6) when the clamping screw 8 has been threaded into the nut 9 to such an extent that the two clamping jaws 5, 6 are pulled against one another. When the clamping screw 8 has been threaded into the nut 9, the clamping screw 8 and the nut 9 are secured captively within the pipe clamp 1.

In order to prevent the nut 9 from leaving its position in the pipe clamp when the clamping screw 8 is no longer threaded into it, tabs 14, 15 are arranged on the clamping jaw 6 at the side of the tunnel 13 where the nut 9 is arranged. The tabs 14, 15 project radially away to the exterior relative to the clamping strip 2. The nut 9 is arranged between the two tabs 14, 15.

The two tabs 14, 15 have inwardly bent shaped portions 16, 17 facing in the direction to the other tab and engaging recesses 18, 19 provided in the circumferential surface of the nut 9. They are positioned on securing surfaces 20, 21 and prevent that the nut 9 can be moved radially away from the clamping strip 2. The securing surfaces 20, 21 have a slant relative to the clamping strip 2 wherein this slant extends in the axial direction (relative to the pipe clamp 1). It is thus not required to bend the shaped portions 16, 17 of the tabs 14, 15 at a right angle. Bending of the ends of the tabs 14, 15, which form the shaped portions 16, 17, by an angle in the range of 20° to 45° is sufficient in order to secure the nut 9 against a radial movement.

The depressions 18, 19 form at the same time counter surfaces 22, 23 for end faces of the flanges 14, 15, i.e., the ends of the shaped portions 16, 17. When the nut 9 is rotated, one of the two counter surfaces 22, 23 contacts the corresponding end face of the shaped portions 16, 17 so that a further rotation is prevented, if the nut 9 is not already secured by clamping by means of the tabs 14, 15 and the shaped portions 16, 17.

The tabs 14, 15 have a main portion 24 which cooperates with the securing surfaces 20, 21 and an additional portion 25 which is arranged on the side of the nut 9 opposite the clamping jaw 6. As can be seen in particular in FIGS. 6 and 7, the additional portion 25 is bent together with the shaped portion 17 inwardly in the direction toward the nut 9 and is thus positioned in front of the nut 9. The nut 9 is thus secured between the additional portion 25 and the portion 12 of the clamping jaw 6. In addition, this configuration has the advantage that the bending of the additional portion 25 also results in a corresponding bending of the shaped portions 16, 17 relative to the tabs 14, 15 so that the manufacture is made easier. Accordingly, only relatively few steps are required in order to secure the nut 9 reliably on the clamping jaw 6.

As can be seen in particular in FIG. 5, a spacing 26 is provided between the tabs 14, 15 and the portion 12 of the clamping jaw 6. This spacing 26 has the advantage that bending of the tabs 14, 15 practically has no effect on the configuration of the portion 12 of the clamping jaw 6 which surrounds the tunnel 13.

The axial spacing (relative to the nut 9) between the additional portion 25 and the portion 12 is greater than the axial length of the nut 9. The nut 9 is thus attached with a certain axial play in the clamping jaw 6 which facilitates handling. Also, a little play in the radial direction can be possible (relative to the pipe clamp 1) which facilitates introduction of the clamping screw 8 into the nut 9. Overall, the nut 9 is however secured in the pipe clamp 1 in the area of the clamping jaw 6 and is held captively. The clamping screw 8 can be threaded into the nut 9 with relatively minimal expenditure.

The manufacture of the clamping jaw 6 is also relatively simple. The clamping jaw 6 can be formed as a bent part in that first the sheet metal is stamped such that the areas for the portion 12 and the tabs 14, 15 are made available. Subsequently, the tabs 14, 15 can be bent together with the portion 12. When the nut 9 is inserted, the shaped portions 16, 17 are bent inwardly, i.e., toward the nut 9.

In the embodiment illustrated in FIGS. 1 through 7, the nut 9 has a substantially square shape which is provided with a total of eight depressions 18, 19 on its circumferential surface. This configuration has the advantage that the nut 9, practically in any orientation in which one surface is parallel to the clamping strip 2, can be mounted in the clamping jaw 6. FIG. 8 shows a series of variations for the nut 9 with which the desired result can be realized in the same, or at least approximately the same, way. Same parts and corresponding parts are identified with the same reference numerals as in FIGS. 1 through 7.

FIG. 8a shows a nut 9a with a substantially circular shape which on its circumferential surface has several recesses 18, 19 which can be engaged in a corresponding way by the shaped portions 16, 17 provided on the tabs 14, 15.

FIG. 8b shows a nut 9b which is substantially of a triangular shape. Recesses 18, 19 can be provided; however, this is not necessarily required. The tabs 14, 15 can be bent with their shaped portions 16, 17 about a section of a slanted surface of the nut 9b and can thus secure the nut 9b against radial movement out of the pipe clamp 1.

FIG. 8c shows a nut 9c which is also of a square shape. This nut 9c is however mounted on its tip so that the shaped portions 16, 17 of the tabs 14, 15 also act on securing surfaces 20, 21 which are slanted relative to the clamping strip 2. In this way, it is not required that the tabs 14, 15 are guided about the entire nut 9.

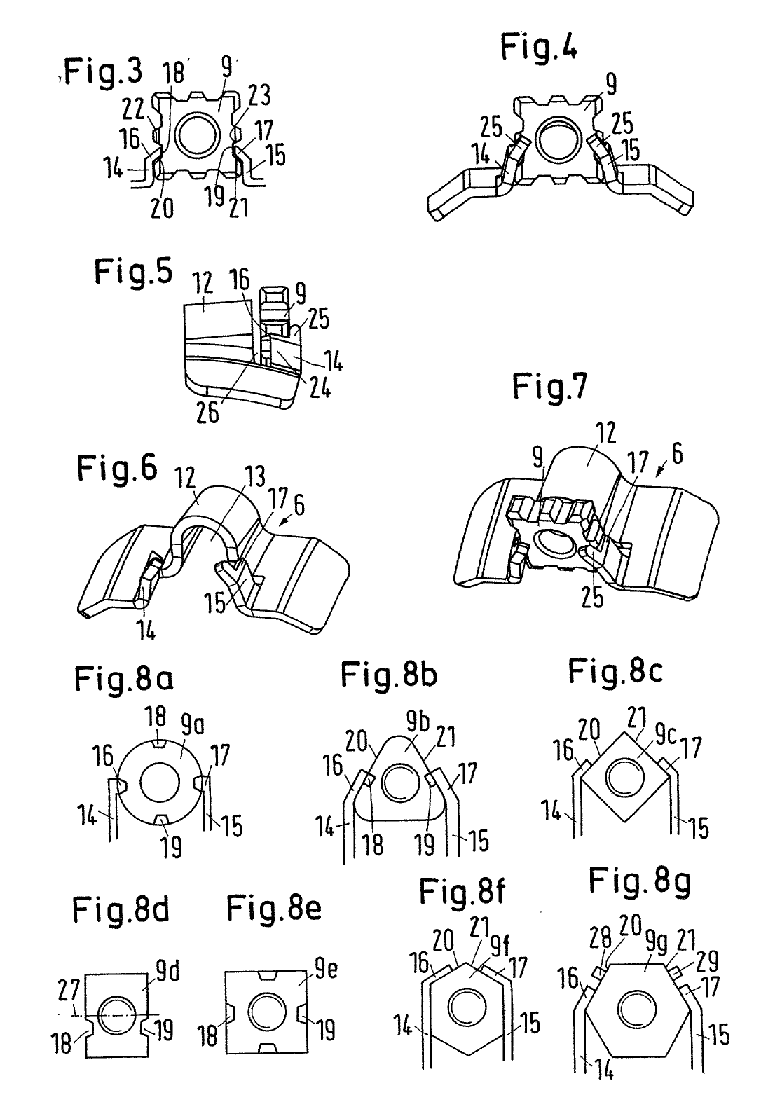

FIG. 8d shows the nut 9d which corresponds substantially to the nut 9 of FIGS. 1 to 7. However, a significantly reduced number of recesses is provided. There are only the recesses 18, 19 which in this case are required for mounting. These recesses 18, 19 are arranged below a center line 27; the recesses 18, 19 (FIG. 3) are in each case arranged underneath a center line. This provides favorable conditions for securing the nut 9d in the area of the clamping jaw 6.

FIG. 8e shows an embodiment in which one nut 9e has a square cross-section and is provided on all four surfaces of the circumferential wall with recesses 18, 19. These recesses 18, 19 are however symmetrically arranged.

FIG. 8f shows a hexagon nut 9f which is mounted on its tip so that securing surfaces 20, 21 result. This nut 9f has, like the nut 9c in FIG. 8c, no recesses in the circumferential wall.

FIG. 8g shows a further nut 9g which is also formed as a hexagon nut. This nut 9g also has securing surfaces 20, 21 which are slanted relative to the clamping strip 2. In addition, on the securing surfaces 20, 21 projections 28, 29 are arranged which form counter surfaces cooperating with end faces of the shaped portions 16, 17.

While specific embodiments of the invention have been shown and described in detail to illustrate the inventive principles, it will be understood that the invention may be embodied otherwise without departing from such principles.

What is claimed is:

1. A pipe clamp comprising:
a clamping strip;
first and second clamping jaws connected to ends of the clamping strip;
a clamping screw and a nut cooperating with the clamping screw for moving the first and second clamping jaws toward one another when tightening the pipe clamp;
two radially projecting tabs provided near the first clamping jaw;
wherein the nut is arranged between the two radially projecting tabs;
wherein at least one of the two radially projecting has a shaped portion which is oriented toward the other one of the two radially projecting
wherein the nut has at least one securing surface;
wherein the shaped portion engages the at least one securing surface of the nut radially relative to the clamping strip.

2. The pipe clamp according to claim 1, wherein the shaped portion is arranged on the end of the at least one of the two radially projecting.

3. The pipe clamp according to claim 1, wherein the shaped portion is bent out of the at least one of the two radially projecting.

4. The pipe clamp according to claim 1, wherein the securing surface is slanted relative to the clamping strip.

5. The pipe clamp according to claim 1, wherein the nut has a circumferential surface and wherein the securing surface is arranged in a depression within the circumferential surface of the nut.

6. The pipe clamp according to claim 1, wherein the at least one of the two radially projecting has a main portion and an additional portion, wherein the main portion cooperates with the securing surface and the additional portion is arranged on a side of the nut facing away from the first clamping jaw.

7. The pipe clamp according to claim 6, wherein the additional portion is longer than the main portion of the tabs.

8. The pipe clamp according to claim 6, wherein the additional portion is bent farther toward the other one of the two radially projecting tabs than the main portion.

9. The pipe clamp according to claim 1, wherein between the two radially projecting and the first clamping jaw a spacing is provided.

10. The pipe clamp according to claim 1, wherein both of the two radially projecting have the shaped portion, respectively.

11. The pipe clamp according to claim 10, wherein the nut has at least one counter surface and wherein at least one of the two radially projecting has an end face cooperating with the at least one counter surface on the nut.
